(19) United States
(12) Patent Application Publication
(10) Pub. No.: US 2003/0088714 A1
(43) Pub. Date: May 8, 2003

(54) User internet interface

(76) Inventors: Scott Madlener, Winnetka, IL (US); Donald Chipman, Chicago, IL (US); Al Kwiatkowski, Chicago, IL (US); Dan Mauer, Chicago, IL (US); Rahmil Magsino, Chicago, IL (US)

Correspondence Address: Lee, Mann, Smith,, McWilliams, Sweeney & Ohlson, P.O. Box 2786, Chicago, IL, 60690-2786, US

(21) Appl. No.: 10/272,238

(22) Filed: Oct. 15, 2002

Related U.S. Application Data
(60) Provisional application No. 60/330,041, filed on Oct. 15, 2001.

(51) Int. Cl. G06F 9/46; G06F 9/00

(52) U.S. Cl. 709/328

(57) ABSTRACT

A system that creates a master (META) user interface in order to combine and coordinate one or more Internet applications and components into a single integrated environment. The META interface resides within one or more browser applications and utilizes one or more interpretive technologies. The META interface allows for independent or interdependent application states during run-time as well as maintaining multiple static or active server connections.

### RELATED APPLICATION

This is the non-provisional filing of provisional application Serial No. 60/330,041, filed on Oct. 15, 2001, entitled “User Internet Interface.”

### BACKGROUND OF THE INVENTION

The Internet of the 1990's was based on the ability to inexpensively mass publish data on the World Wide Web. Companies “connected” their internal systems and consumers purchased goods while viewing advertising on websites. The Internet was an active media that required people to enter the URL of their choice to access a specific website.

As companies grow, they typically expand their physical locations geographically in order to conduct business “closer” to their customers. These peripheral geographic locations are called satellite or branch offices. Similarly, on the web, companies are discovering their need to conduct business “closer” to their customers. However, since the web has no geographic boundaries, the concept of “closer” is subtle. The present invention defines “closer” as moving the desired content towards the user's specific platforms while making the desired content more usable. This concept is called “lifestyle computing.”

With the concept of “lifestyle computing” in mind, the present invention creates a unique and novel method of developing personalized applications that act as communication interfaces between a user and Internet based data. These interfaces are designed to solve a specific communication need for a specific user, however, these needs typically fall into one of three categories: Workflow, E-Commerce, or Content Distribution. Traditionally, if a person wants to “get” information from the web, they need to “go” to the data. Similarly, if a company wants to “broadcast” information to users, they need to wait until the user comes to their site. This action is what makes the web an active medium and is referred to as the “User Request Model.” The method described in the present application provides a real-time ability to move data toward the end user referred to as the “Event Driven Model” of data distribution, wherein the end users may or may not choose when their interface is updated with new information, similar to traditional ‘broadcast’ media.

For the infrequent user, the User Request Model is sufficient. However, heavy users of given web based data typically need to employ a process of “refreshing” their screen(s) multiple times to interact with the latest data.

The present invention solves the needs of the heavy users without causing the user to perform any action to gain access to the data of desire. Additionally, the present invention also creates the ability for an advertiser to directly distribute personalized and dynamic data in real-time via the HTTP protocol.

The method described in this application creates a master (META) user interface that takes the remote data, located on Internet-based central servers, and delivers this data to specific users on the users' local platform of choice currently consisting of their: computer ‘desktop,’ email, handheld device, or website.

### SUMMARY OF THE INVENTION

The User Internet Interface method and system integrates many primary roles of the browser and Controlling Technology within the interface application. Thus reducing the importance of the Browser and Controlling Technology to subordinate roles.

The interface has been designed to gather, hold, transmit and execute its own data and operational characteristics with or without the support of the browser. As such, the interface is somewhat independent and will act as a META application for other applications and components subsequently requested.

### BRIEF DESCRIPTION OF THE DRAWINGS

The invention is described in greater detail in the following description of examples embodying the best mode of the invention, taken in conjunction with the drawing figures, in which:

FIG. 1 is flow diagram of a one complete cycle of the interface as described by the invention.

### DESCRIPTION OF EXAMPLES EMBODYING THE BEST MODE OF THE INVENTION

### Applications and Components

A unique feature of the META interface is its ability to incorporate several applications and/or application components from different sources, and to allow those applications and components to interoperate. An application is defined as a self-contained unit, including functionality and user interface, which can operate on its own or in tandem with other applications (an example would be a video player with play/stop/fast-forward/rewind buttons). An application component is defined as a unit, also including functionality and user interface, which is intended only to operate as part of a larger application (the control buttons in the aforementioned video player, for example, could be loaded as an external application component).

### Contents User and Application Data

Each application and/or component can contain various types of content (text, video, audio, computer routines, etc). This content can either be of a static nature, or, alternately, it can be personalized based on a central repository of User Data (including demographic, psychographic, environmental, etc.). The data in this repository is linked directly to each individual user through the use of variables or cookies, and can be utilized by either the application or component itself, or by the server. In other words, it is possible for data to be personalized on either the client side or the server side, or both.

### Browser

The Interface system is designed to reside within client software applications that contain or launch the Application Interpreter, and which connects to the Internet via traditional protocols such as HTTP, UDP, etc. These applications (browsers) may or may not be apparent to the end user, and often take the current form of Web Browsers, Java Interpreters, multi-media players, eMail Clients, Word Processing Applications, etc. Often the Browser carries or submits variables, which can be used by the Interface.

### Server Connections

Each application and/or component of the META Interface can optionally be connected to an arbitrary number of servers on the Internet or on a localized intranet. These connections can take place over a variety of protocols (HTTP and UDP being the most commonly applied), and the server(s) can include many varying technologies-examples of servers include Web Servers, Database Servers, Streaming Media Servers, and or Communication Servers. Since an individual component can connect to multiple servers simultaneously, data from different sources can be aggregated or redistributed, and data from one server can be used to augment or modify data from another server. Server connections can be added, removed and activated based on dynamically loaded content and/or remotely controlled functions within the interface.

### Controlling Technology or Application Interpreter

The Application Interpreter is a layer that sits on top of the Browser and executes a program written in and compiled in the language of the Controlling Technology. The execution of this program takes place in a protected, secure environment, and can appear within the browser or a number of other internet-connected applications. It is also possible in some cases for the Interpreter to execute separately from the browser.

### Rendering of Output

The META interface uses the Controlling Technology to manipulate the content, applications and components into a presentation whose operation is intuitive to the end-user or server. Different representations of interactive elements can be manipulated and rendered in different ways for different purposes; for example, if three application components are loaded into one interface, the META interface can render them with a common visual appearance. Data received by an application or component can be manipulated by the server or by the META interface.

### User Internet Interface

For the purpose of promoting an understanding of the principles of the invention, reference will be made to the embodiments illustrated in the drawings. It will, nevertheless, be understood that no limitation of the scope of the invention is thereby intended, such alterations and further modifications in the illustrated device, and such further applications of the principles of the invention illustrated herein, being contemplated as would occur to the one skilled in the art to which the invention relates.

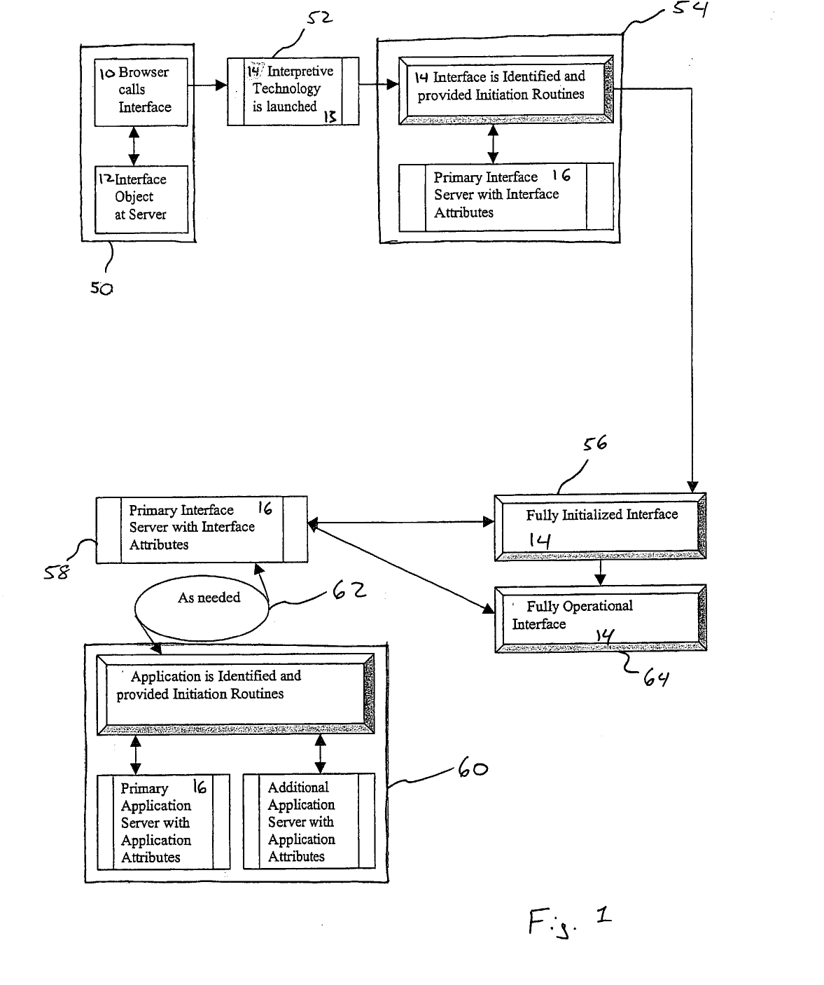

As shown in FIG. 1, a browser 10, or browser equivalent makes a request to an interface object 12, as is shown by step 50. Once the request is received by the interface object 12 the browser 10 launches an interpretive application 13, shown in step 52. The interface object 12 is then loaded into the interpretive application 13 and makes a call to a primary interface server 16 where a META interface 14 is then initialized and identified, shown in step 54. The primary interface server 16 provides identification and initialization routines, which are collectively referred to as Interface Attributes, and the interface 14 becomes fully initialized, as shown in step 56.

As shown in step 58, the interface 14 coordinates the interface primary server 16 with any additional applications or Interface identifications and their appropriate primary servers 16. As shown by optional step 60, each application within the interface 14 contacts additional servers 16 for their application's own identification and initialization. The process whereby the interface 14 conducts an initialization of certain applications will terminate when all applications have been loaded and initialized.

Once all applications have been loaded and initialized, the interface 14 simultaneously executes one or more of the applications as needed, shown in step 64. As the applications are being executed, the interface 14 confirms with the primary servers 16 for updates and broadcasts in a manner as requested by individual applications. As the time between updates and broadcasts are cut down, the interface 14 begins approaching what is known as a real-time broadcast where the updates occur almost instantaneously.

The interface 14 may be used in different computer environments. For instance, because the interface 14 is designed as a META application, it can call and execute one or more applications during run-time, as shown in steps 60 and 62. While these applications co-exist within the interface 14, they act as instances of a META application themselves, and thus can host one or more META applications themselves as sub (or child) processes in the same way the Controlling Technology hosts the primary interface 14. Likewise, these child processes may have one or more child processes of their own, and so on. Therefore, applications within the interface 14 can recursively include n levels of similar applications, provided that they all meet the basic criteria required to operate within the interface 14.

Additionally, another environment in which the interface 14 can operate is with regard to independent or interdependent applications. Applications are either independent of or interdependent with any other application within the interface 14 environment. An application may be independent of one or more applications within the interface 14, while being interdependent with the rest, or any combination thereof. If an application retains a persistent state regardless of the activities of another application within the Controlling Technology, that application is said to be independent of the other application. The independent application will retain its state until it receives data supplied from any source from which it is not independent, such as a user interaction or a function call from a server. Conversely, interdependent applications share data between one another, using information gained by one application to populate data fields or initiate functions within others. An interdependent application may gain a piece of information from a given source and then share that information with other applications within the Controlling Technology, which would use the information to perform various application-specific tasks. For example, one application may require a user to enter a zip code. Once the zip code has been entered, the application would make that information available to other applications within the Controlling Technology. A mapping application could bring up a map based on that zip code, or a different application could display movies playing within that zip code, etc.

Various features of the invention have been particularly shown and described in connection with the illustrated embodiments of the invention. However, it must be understood that these particular products, and their method of manufacture, do not limit but merely illustrate, and that the invention is to be given its fullest interpretation within the terms of the appended claims.

We claim:

1. A method for combining and coordinating Internet applications into a single integrated environment, comprising the steps of:
a. accessing an interface object at a server;
b. initializing the interface object through a primary server;
c. the interface communicating with the primary server and acquiring additional applications; and
d. executing applications simultaneously through the interface.

2. The method according to claim 1, in which the applications are recursively imbeddable.

3. The method according to claim 1, in which the simultaneous execution of the applications occurs in real time.

4. A method for combining and coordinating Internet applications into a single integrated environment and broadcasting the applications in real-time, comprising the steps of:
a. requesting an interpretive application from an interface;
b. launching the application into which the interface is loaded;
c. initializing and identifying the application through a server wherein the interface is fully initialized;
d. coordinating the identification and initialization of additional applications between the interface and the server; and
e. simultaneously executing the applications between the interface and the server.

5. The method according to claim 4, in which the applications are recursively imbeddable.

6. The method according to claim 4, in which the execution intervals of the simultaneous applications may be controlled by a user.

7. The method according to claim 4, in which the initialization and identification of additional applications is performed until all applications available have been initialized and identified.
